(19) United States
(12) Patent Application Publication
(10) Pub. No.: US 2024/0289012 A1
(43) Pub. Date: Aug. 29, 2024

(54) PAGE SWITCHING METHOD, PAGE SWITCHING APPARATUS, ELECTRONIC DEVICE AND READABLE STORAGE MEDIUM

(71) Applicant: Beijing Zitiao Network Technology Co., Ltd., Beijing (CN)

(72) Inventor: Weiyi CHANG, Beijing (CN)

(21) Appl. No.: 18/572,632

(22) PCT Filed: Oct. 28, 2022
(86) PCT No.: PCT/CN2022/128185

§ 371 Date: Dec. 20, 2023

(30) Foreign Application Priority Data
Oct. 28, 2021 (CN) 202111262663.7

(51) Int. Cl. G06F 3/0488; G06F 3/0481; G06F 3/0484

(52) U.S. Cl. CPC G06F 3/0488; G06F 3/0481; G06F 3/0484

(57) ABSTRACT

The present disclosure provides an interface displaying method, an interface displaying apparatus, an electronic device and a readable storage medium. A first movable control is displayed in a first display interface. The method includes: acquiring a first dragging for the first movable control; determining target display content to be displayed in response to the first dragging; and displaying the target display content in the second display interface for replacing the displaying of the first display interface.

### CROSS REFERENCE TO RELARED APPLICATION

The present application claims the priority of Chinese Patent Application No. 202111262663.7 filed on Oct. 28, 2021, which is hereby incorporated by reference in its entirety as part of the present application.

### TECHNICAL FIELD

Embodiments of the present disclosure relate to an interface switching method, an interface switching apparatus, an electronic device and a readable storage medium.

### BACKGROUND

In recent years, with the increasing complexity and optimization of functions of various electronic devices such as a smartphone and a tablet computer, touch screens that replace keyboards to implement man-machine interaction are widely used in various devices. At present, technologies for implementing man-machine interaction by performing a touch operation on a touch screen are widespread, and in general, the touch operation may include a click operation and a slide operation. Methods for switching displayed interfaces include clicking a tab of a corresponding interface, sliding on the touch screen in a certain direction, and clicking a corresponding position of the touch screen to turn the interface forward or backward, and the like.

### SUMMARY

The present disclosure relates to an interface switching method, an interface switching apparatus, an electronic device and a readable storage medium, and proposes to implement interfaces switching through a visual operation, to enhance the interactivity of interaction operations and to enrich man-machine interaction operation modes.

According to an aspect of the present disclosure, an interface switching method is provided. A first movable control is displayed in a first display interface of a target application. The method includes: acquiring a first dragging operation for the first movable control; determining switching display content to be displayed in response to the first dragging operation triggering an interface switching action; and switching from the first display interface to a second display interface of the target application, and displaying the switching display content in the second display interface.

According to some embodiments of the present disclosure, the determining switching display content to be displayed in response to the first dragging operation triggering an interface switching action includes: in response to the first dragging operation corresponding to dragging the first movable control to a target area in the first display interface, determining to perform the interface switching action and determining the switching display content.

According to some embodiments of the present disclosure, the interface switching method further includes: displaying transitional content in the first display interface after the first dragging operation for the first movable control is detected, wherein the transitional content includes the first movable control, the first movable control being displayed in a mobile manner along with touch coordinates of the first dragging operation.

According to some embodiments of the present disclosure, the first movable control being displayed in a mobile manner along with touch coordinates of the first dragging operation includes: when the first movable control is displayed in the mobile manner along with touch coordinates of the first dragging operation, the first movable control changes.

According to some embodiments of the present disclosure, the transitional content further includes a background image obtained based on a current display content picture in the first display interface; and/or the transitional content further includes a foreground image obtained based on an interface color attribute of the second display interface.

According to some embodiments of the present disclosure, the displaying transitional content in the first display interface includes: displaying a shape of the target area in the first display interface; and determining to perform the interface switching action in response to the touch coordinates of the first dragging operation being within the shape of the target area.

According to some embodiments of the present disclosure, the interface switching method further includes: displaying text information associated with the first dragging operation within the shape of the target area.

According to some embodiments of the present disclosure, the first movable control is displayed in a first predetermined shape, the target area is displayed in a second predetermined shape, and the first predetermined shape is associated with the second predetermined shape.

According to some embodiments of the present disclosure, the first movable control being displayed in a mobile manner along with touch coordinates of the first dragging operation includes: changing a display effect of the first predetermined shape in a process when the first movable control is displayed in a mobile manner along with touch coordinates of the first dragging operation, and associating the display effect of the first predetermined shape with the second predetermined shape in a case that the touch coordinates of the first dragging operation reach the target area.

According to some embodiments of the present disclosure, the switching display content includes N sub-categories of display content, N is an integer greater than 1, the first display interface is divided into N dragging angle ranges with a position of the first movable control displayed in the first display interface as a dragging starting position, and the N dragging angle ranges respectively correspond to the N sub-categories of display content, the determining switching display content to be displayed in response to the first dragging operation triggering an interface switching action includes: determining a dragging angle range to which a dragging angle of the first dragging operation belongs among the N dragging angle ranges, and determining the corresponding switching display content based on the dragging angle range to which the dragging angle belongs.

According to some embodiments of the present disclosure, the interface switching method further includes: displaying transitional content in the first display interface after the first dragging operation for the first movable control is detected, wherein the transitional content is associated with the dragging angle range to which the dragging angle of the first dragging operation belongs among the N dragging angle ranges.

According to some embodiments of the present disclosure, the switching display content includes N sub-categories of display content, N is an integer greater than 1, and the first display interface is divided into N dragging areas, and the N dragging areas respectively correspond to the N sub-categories of display content, the determining switching display content to be displayed in response to the first dragging operation triggering an interface switching action includes: determining a dragging area to which a dragging arrival position of the first dragging operation in the first display interface belongs among the N dragging areas, and determining the corresponding switching display content based on the dragging area to which the dragging arrival position belongs.

According to some embodiments of the present disclosure, the interface switching method further includes: displaying transitional content in the first display interface after the first dragging operation for the first movable control is detected, wherein the transitional content is associated with the dragging area to which the dragging arrival position of the first dragging operation in the first display interface belongs among the N dragging areas.

According to some embodiments of the present disclosure, before switching to the second display interface is performed, current display content is displayed in the first display interface, and the method further includes: acquiring a second dragging operation for a second movable control in the second display interface after displaying the switching display content in the second display interface; and in response to the second dragging operation corresponding to dragging the second movable control to a predetermined area, switching to the first display interface and displaying the current display content in the first display interface.

According to some embodiments of the present disclosure, the current display content is one of a data stream corresponding to visual content and a data stream corresponding to auditory content, and the switching display content is the other one of the data stream corresponding to the visual content and the data stream corresponding to the auditory content.

According to another aspect of the present disclosure, an interface switching apparatus is provided. The interface switching apparatus includes: a display unit configured to: display a first movable control in a first display interface of a target application; a touch response unit configured to: acquire a first dragging operation for the first movable control; and a processing unit configured to: determine switching display content to be displayed in response to the first dragging operation triggering an interface switching action, and switch from the first display interface to a second display interface of the target application and control the display unit to display the switching display content in the second display interface.

According to some embodiments of the present disclosure, the determining switching display content to be displayed in response to the first dragging operation triggering an interface switching action by the processing unit includes: in response to the first dragging operation corresponding to dragging the first movable control to a target area in the first display interface, determining to perform the interface switching action and determining the switching display content.

According to some embodiments of the present disclosure, the processing unit is further configured to: control the display unit to display transitional content in the first display interface after the first dragging operation for the first movable control is detected, wherein the transitional content includes the first movable control, and the first movable control is displayed in a mobile manner along with touch coordinates of the first dragging operation.

According to some embodiments of the present disclosure, the first movable control being displayed in a mobile manner along with touch coordinates of the first dragging operation includes: when the first movable control is displayed in the mobile manner along with touch coordinates of the first dragging operation, the first movable control changes.

According to some embodiments of the present disclosure, the transitional content further includes a background image obtained based on a current display content picture in the first display interface; and/or the transitional content further includes a foreground image obtained based on an interface color attribute of the second display interface.

According to some embodiments of the present disclosure, the displaying transitional content in the first display interface by the display unit includes: displaying a shape of the target area in the first display interface; and determining to perform the interface switching action in response to the touch coordinates of the first dragging operation being within the shape of the target area.

According to some embodiments of the present disclosure, the processing unit is further configured to control the display unit to display text information associated with the first dragging operation within the shape of the target area.

According to some embodiments of the present disclosure, the first movable control is displayed in a first predetermined shape, the target area is displayed in a second predetermined shape, and the first predetermined shape is associated with the second predetermined shape.

According to some embodiments of the present disclosure, the first movable control being displayed in a mobile manner along with touch coordinates of the first dragging operation includes: changing a display effect of the first predetermined shape in a process when the first movable control is displayed in a mobile manner along with touch coordinates of the first dragging operation, and associating the display effect of the first predetermined shape with the second predetermined shape in a case that the touch coordinates of the first dragging operation reach the target area.

According to some embodiments of the present disclosure, the switching display content includes N sub-categories of display content, N is an integer greater than 1, the first display interface is divided into N dragging angle ranges with a position of the first movable control displayed in the first display interface as a dragging starting position, and the N dragging angle ranges respectively correspond to the N sub-categories of display content, the determining switching display content to be displayed in response to the first dragging operation triggering an interface switching action by the processing unit includes: determining a dragging angle range to which a dragging angle of the first dragging operation belongs among the N dragging angle ranges, and determining the corresponding switching display content based on the dragging angle range to which the dragging angle belongs.

According to some embodiments of the present disclosure, the processing unit is further configured to display transitional content in the first display interface after the first dragging operation for the first movable control is detected, wherein the transitional content is associated with the dragging angle range to which the dragging angle of the first dragging operation belongs among the N dragging angle ranges.

According to some embodiments of the present disclosure, the switching display content includes N sub-categories of display content, N is an integer greater than 1, and the first display interface is divided into N dragging areas, and the N dragging areas respectively correspond to the N sub-categories of display content, the determining switching display content to be displayed in response to the first dragging operation triggering an interface switching action by the processing unit includes: determining a dragging area to which a dragging arrival position of the first dragging operation in the first display interface belongs among the N dragging areas, and determining the corresponding switching display content based on the dragging area to which the dragging arrival position belongs.

According to some embodiments of the present disclosure, the processing unit is further configured to display transitional content in the first display interface after the first dragging operation for the first movable control is detected, wherein the transitional content is associated with the dragging area to which the dragging arrival position of the first dragging operation in the first display interface belongs among the N dragging areas.

According to some embodiments of the present disclosure, before switching to the second display interface is performed, current display content is displayed in the first display interface, and the processing unit is further configured to: acquire a second dragging operation for a second movable control in the second display interface after displaying the switching display content in the second display interface; and in response to the second dragging operation corresponding to dragging the second movable control to a predetermined area, switch to the first display interface and display the current display content in the first display interface.

According to some embodiments of the present disclosure, the current display content is one of a data stream corresponding to visual content and a data stream corresponding to auditory content, and the switching display content is the other one of the data stream corresponding to the visual content and the data stream corresponding to the auditory content.

According to another aspect of the present disclosure, an electronic device is provided. The electronic device includes a memory, a processor and a computer program stored in the memory, wherein the processor executes the computer program to implement the steps of the interface switching method according to the present disclosure.

According to another aspect of the present disclosure, a computer-readable storage medium is provided. The computer-readable storage medium has a computer program stored thereon, wherein the computer program, when executed by a processor, implements the steps of the interface switching method according to the present disclosure.

By the interface switching method, the interface switching apparatus, the electronic device and the readable storage medium provided by embodiments of the present disclosure, interface switching can be implemented according to a dragging operation for a movable control, such that operation modes of user interaction can be enriched, the diversity and interactivity of user interaction modes can be improved, and the operation experience of user man-machine interaction can be further improved.

### BRIEF DESCRIPTION OF THE DRAWINGS

In order to provide a clearer explanation of the disclosed embodiments or technical solutions in the prior art, a brief introduction will be given to the accompanying drawings required in the description of the embodiments or prior art. It is obvious that the accompanying drawings in the following description are only some embodiments of the present disclosure. For ordinary technical personnel in the art, other accompanying drawings can be obtained based on these drawings without any creative effort.

FIG. 1 shows a schematic flowchart of an interface switching method according to some embodiments of the present disclosure;

FIG. 2 shows a schematic diagram of a mobile terminal implementing the interface switching method according to some embodiments of the present disclosure;

FIG. 3 shows a schematic diagram of an application scenario for implementing the method according to some embodiments of the present disclosure;

FIG. 4 shows a schematic diagram of a first display interface including a first movable control;

FIG. 5 shows a schematic diagram of transitional content according to some embodiments of the present disclosure;

FIG. 6 shows another schematic diagram of transitional content according to some embodiments of the present disclosure;

FIG. 7A shows a schematic diagram of a second display interface after switching;

FIG. 7B shows another schematic diagram of the second display interface after switching;

FIG. 8 shows a schematic diagram of a second display interface including a second movable control;

FIG. 9 shows a schematic diagram of a dragging angle range according to some embodiments of the present disclosure;

FIG. 10 shows a schematic block diagram of an interface switching apparatus according to some embodiments of the present disclosure;

FIG. 11 shows a schematic block diagram of an electronic device according to some embodiments of the present disclosure;

FIG. 12 shows an architectural schematic diagram of an exemplary computing device according to some embodiments of the present disclosure; and

FIG. 13 shows a schematic block diagram of a computer-readable storage medium according to some embodiments of the present disclosure.

### DETAILED DESCRIPTION

The following will provide a clear and complete description of the technical solution in the disclosed embodiments in conjunction with the accompanying drawings. Obviously, the described embodiments are only a portion of the embodiments disclosed in this disclosure, and not all of them. Based on the embodiments in this disclosure, all other embodiments obtained by ordinary technical personnel in the art without the creative labor belong to the scope of protection in this disclosure.

The terms “first”, “second”, and similar terms used in this disclosure do not indicate any order, quantity, or importance, but are only used to distinguish different components. Similarly, words such as “including” or “comprising” refer to the components or objects that appear before the word, including the components or objects listed after the word and their equivalents, without excluding other components or objects. Words such as “connection” or “connecting” are not limited to physical or mechanical connections, but can include electrical connections, whether direct or indirect.

The interactive process of touch screen-based touch operations is relatively simple in terms of implementation. For example, it is mainly implemented by clicking icons and sliding interfaces, such that the operation action is single and the operation effect is not intuitive, which limits the interaction experience of users in interface switching.

Some embodiments of the present disclosure provide an interface switching method, which implements switching between two or more display interfaces in a target application based on movable controls displayed in the interfaces, such that a user may implement the switching between different display interfaces through an intuitive control dragging operation, and existing interface switching operation modes are enriched, which facilitates the improvement of an operation effect of interaction between the user and, for example, a terminal device.

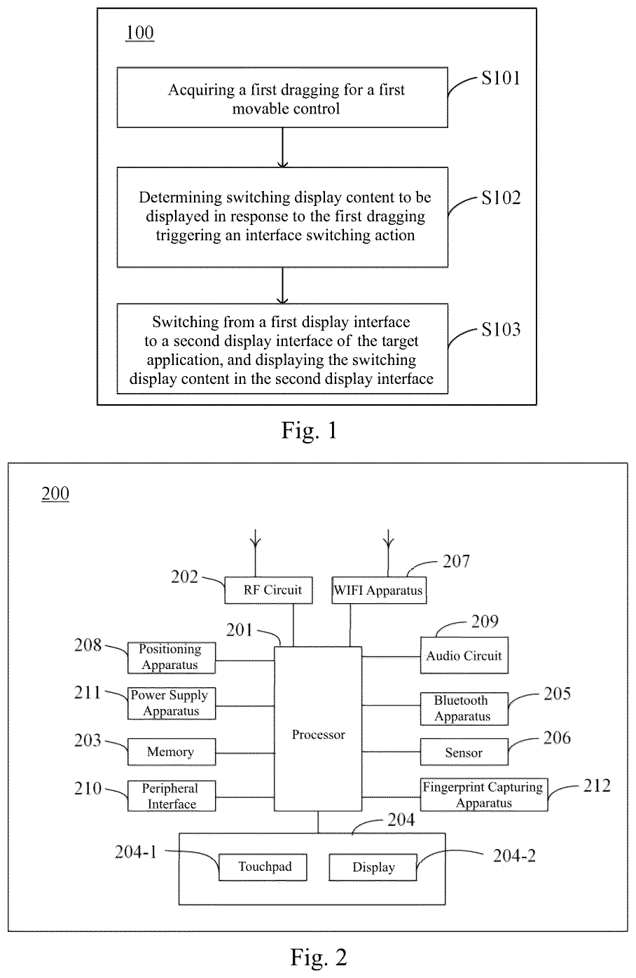

FIG. 1 shows a schematic flowchart of an interface switching method according to some embodiments of the present disclosure. As shown in FIG. 1, an interface switching method 100 according to some embodiments of the present disclosure may include steps S101-S103.

In the interface switching method according to some embodiments of the present disclosure, firstly, a first movable control is displayed in a first display interface of a target application. The target application may be an application program installed in the device. Specifically, the first movable control may collect touch operations for the first movable control, to determine touch operation parameters based on the detected touch operation, such that corresponding responses can be made based on the determined touch operation parameters which may include, for example, a touch starting point, a dragging distance, a dragging direction and the like. For example, the movable control may be displayed on a display screen of the terminal device, and the user may select and drag the displayed control by touching or dragging, etc., and the terminal device receives a user operation based on the control and takes the user operation as user input information for implementing subsequent processing. As an example, the first movable control may be implemented by various programming languages, for example, computer languages such as HTML and Js, which are not limited here.

Firstly, as shown in FIG. 1, at step 101, a first dragging operation for a first movable control is acquired. For example, the movable control may be a control which is displayed on a display interface of an electronic device and may be displaced by dragging, and a user of the electronic device may select the control and drag the control to be displaced as user input information. As an example, the movable control may be displayed at any suitable position of the display interface, and may receive a dragging operation on a touchpad by a user.

It can be understood that the user referred to herein may refer to an operator capable of operating the electronic device, and the user may be specific to the electronic device, for example, by logging in account information in the application program of the electronic device. In a login process, the device may send verification information to a server (for example, corresponding to a platform or a provider of the application program installed on the electronic device). As an example, a video playing application program may be installed on the electronic device, and the electronic device receives the verification information input into the video playing application program by the user, so as to implement the account login process. In addition, the electronic device may also send the received verification information to the server, and receive data sent by the server for a logged-in account. For example, the data may include video data to be played on the electronic device and related indication information for implementing a video playing function.

Next, at step S102, switching display content to be displayed is determined in response to the first dragging operation triggering an interface switching action.

As an example, the triggering the interface switching action may refer to triggering the electronic device to switch from a first display interface currently displayed to a second display interface to be displayed, wherein the switching display content displayed on the second display interface may be different from the current display content displayed on the first display interface, and the second display interface and the first display interface correspond to the same target application. Specifically, triggering may be understood as a starting point that urges the terminal device to perform a certain process or operation. It can be understood that an event of triggering interface switching may also trigger other operations besides the interface switching operation synchronously, which are not limited here.

As an example, the current display content may be one of a data stream corresponding to visual content and a data stream corresponding to auditory content, and the switching display content is the other one of the data stream corresponding to the visual content and the data stream corresponding to the auditory content.

The above-mentioned data stream corresponding to visual content may be or may not be associated with the data stream corresponding to auditory content. As an example, the data stream corresponding to visual content may be video data such as a short video, etc. In addition, it can be understood that the data stream corresponding to visual content may also include an audio data stream, that is, the video data includes both image content and audio content. The data stream corresponding to auditory content may be a data stream of content such as music, a radio, a broadcast, etc. That is to say, the data stream corresponding to visual content may refer to data content for visual consumption by the user, while the data stream corresponding to auditory content may refer to data content for auditory consumption by the user. As an example, the data stream corresponding to auditory content may be applied to, for example, situations where it is inconvenient for the user to watch or operate a terminal display screen, for example, during driving.

It can be understood that the term “displaying” herein may refer to operations such as displaying a video and an image, or playing an audio, to display information to users, for example. For example, displaying a data stream corresponding to visual content may be understood as displaying visual consumption content such as a video and a picture, and at the same time playing an audio associated with the displayed visual content, such as background music, dubbing and the like, through a speaker, for example. For another example, displaying a data stream corresponding to auditory content may be understood as playing auditory consumption content such as a radio, music and an electronic novel.

The step of determining the switching display content to be displayed will be described in detail below in combination with the implementations.

Next, as shown in FIG. 1, at step S103, switching from the first display interface to the second display interface of the target application is performed, and the switching display content is displayed in the second display interface.

By the interface switching method according to some embodiments of the present disclosure, the switching of display interfaces can be implemented based on the displayed movable control, such that the switching between different display interfaces may be implemented through the intuitive dragging operation, the interaction operation is simple. Visual display effect, implementation of operations and other aspects of the present disclosure are simpler and more intuitive than the existing operation modes such as clicking, double-clicking and sliding, which facilitates the improvement of an operation effect of interaction between the user and, for example, a terminal device.

Further, in some embodiments according to the present disclosure, the current display content is one of a data stream corresponding to visual content and a data stream corresponding to auditory content, and the switching display content displayed on the second display interface after interface switching is performed is the other one of the data stream corresponding to the visual content and the data stream corresponding to the auditory content. Based on this, in some implementations, the interface switching method according to the embodiment of the present disclosure may be exemplarily applied to application scenarios of the above two types of display interfaces, for example, the first display interface currently displayed and the second display interface after the interface switching is performed are respectively used to display different types of display content. That is, the user can implement the switching between two types of display content merely based on the proposed simple and intuitive interface switching method, such that the operation interactivity of the user is enriched and the convenience of switching different types of interfaces is increased. For example, when the user consumes the data stream corresponding to visual content displayed in the first display interface, the user may need to switch to a situation where it is inconvenient to operate the terminal, such as a driving mode. Thus, the user may perform interface switching based on the interface switching method provided according to some embodiments of the present disclosure, to directly switching from the current display interface corresponding to the visual content to the display interface after switching corresponding to the auditory content, thereby continuously obtaining the accompanying and entertainment services of a product. Meanwhile, this is advantageous for increasing user stickiness for the application program and for maintaining the user volume.

It can be understood that the interface switching method provided according to some embodiments of the present disclosure may also be applied to other application scenarios requiring interface switching, which is not limited by the present disclosure.

Next, an exemplary electronic device implementing the interface switching method according to the embodiment of the present disclosure will be described.

The electronic device may be a mobile terminal, a desktop computer, a tablet computer, a personal computer (PC), a personal digital assistant (PDA), a smartwatch, a netbook, a wearable electronic device, an Augmented Reality (AR) device, etc., in which an application program can be installed and an icon of the application program be displayed, and the specific form of the electronic device is not limited by the present disclosure.

In at least some embodiments, the interface switching method according to the embodiment of the present disclosure may be implemented in a mobile terminal 200 such as in FIG. 2.

As shown in FIG. 2, the mobile terminal 200 may specifically include: a processor 201, a radio frequency (RF) circuit 202, a memory 203, a touch screen 204, a Bluetooth apparatus 205, one or more sensors 206, a wireless fidelity (WI-FI) apparatus 207, a positioning apparatus 208, an audio circuit 209, a peripheral interface 210 and a power supply apparatus 211 and other components. These components may communicate with one another through one or more communication buses or signal lines (not shown in FIG. 2). It may be understood by those skilled in the art that a hardware structure shown in FIG. 2 does not constitute a limitation on the mobile terminal, and the mobile terminal 200 may include more or less components than shown, or a combination of some components, or a different component arrangement.

The various components of the mobile terminal 200 will be described in detail below in conjunction with FIG. 2.

Firstly, the processor 201 is a control center of the mobile terminal 200, which is connected with various parts of the mobile terminal 200 by various interfaces and lines, and executes various functions and processing data of the mobile terminal 200 by running or executing application programs stored in the memory 203 and calling data stored in the memory 203. In some embodiments, the processor 201 may include one or more processing units. By way of example, the processor 201 may be various processor chips.

The RF circuit 202 may be configured to receive and send wireless signals in a process of sending and receiving information or talking. In particular, the RF circuit 202 may receive downlink data from a base station and send the downlink data to the processor 201 for processing, and additionally send involved uplink data to the base station. Generally, the RF circuit includes, but is not limited to, an antenna, at least one amplifier, a transceiver, a coupler, a low noise amplifier, a duplexer, etc. In addition, the RF circuit 202 may also communicate with other devices through wireless communication. The wireless communication may use any communication standard or protocol, including but not limited to a global system for mobile communications, a general packet radio service, code division multiple access, wideband code division multiple access, long term evolution, E-mail, a short message service, etc.

The memory 203 is configured to store application programs and related data, and the processor 201 executes various functions and data processing of the mobile terminal 200 by running the application programs and the data stored in the memory 203. The memory 203 mainly includes a storage program area and a storage data area, wherein the storage program area may store an operating system and an application program required by at least one function (for example, an audio data playing function, a video data playing function); the storage data area may store data (e.g., audio data, video data, playback record information, etc.) created according to the use of the mobile terminal 200. In addition, the memory 203 may include a high-speed random access memory (RAM), and may also include nonvolatile memories, such as a disk memory device, a flash memory device or other volatile solid-state memory devices. The memory 203 may store various operating systems. The above-mentioned memory 203 may be independent and connected to the processor 201 through the communication bus. In addition, the memory 203 may be integrated with the processor 203.

The touch screen 204 may specifically include a touchpad 204-1 and a display 204-2.

The touchpad 204-1 may capture touch operations (alternatively referred to as touch events) on or near the touchpad 204-1 by a user of the mobile terminal 200, such as an operation on or near the trackpad 204-1 by a user using a finger, a stylus, or any suitable object, and send captured touch information to another device (e.g., the processor 201). The touch event of the user near the touchpad 204-1 may be called floating touch. The floating touch may mean that the user does not need to directly touch the touchpad 204-1 in order to select, move or drag an object (for example, an icon), but rather merely being in proximity to the device in order to perform a desired function. In addition, the touchpad 204-1 may be implemented as various types, such as resistive, capacitive, infrared and surface acoustic wave touchpads.

The display (or called a display screen) 204-2 may be configured to display information input by the user or information provided to the user and various menus of the mobile terminal 200. The display 204-2 may be configured in the form of a liquid crystal display, an organic light emitting diode, or the like. The touchpad 204-1 may be overlaid on the display 204-2. When the touchpad 204-1 detects a touch event on or near it, the touchpad delivers the touch event to the processor 201 to determine parameters of the touch event, and then the processor 201 may provide corresponding output data, such as video data or audio data, on the display 204-2 according to the parameters of the touch event. Although in FIG. 2 the touchpad 204-1 and the display screen 204-2 implement input and output functions of the mobile terminal 200 as two independent components, in some embodiments, the touchpad 204-1 and the display screen 204-2 may be integrated to implement the input and output functions of the mobile terminal 200. It can be understood that the touch screen 204 is made of multiple layers of materials that are stacked, only the touchpad (layer) and the display screen (layer) are shown in FIG. 2, and other layers are not described in FIG. 2. In addition, the touchpad 204-1 may be configured on a front surface of the mobile terminal 200 in the form of a full panel manner, and the display screen 204-2 may also be configured on the front surface of the mobile terminal 200 in the form of a full panel manner, such that a frameless structure may be implemented on the front surface of the terminal device.

Further, the mobile terminal 200 may also have a fingerprint recognition function. For example, a fingerprint capturing device 212 may be configured on a back surface of the mobile terminal 200 (for example, below a rear camera), or the fingerprint capturing device 212 may be configured on the front surface of the mobile terminal 200 (for example, below the touch screen 204). For another example, the fingerprint capturing device 212 may be configured in the touch screen 204 to implement the fingerprint recognition function, that is, the fingerprint capturing device 212 may be integrated with the touch screen 204 to implement the fingerprint recognition function of the mobile terminal 200. In this case, the fingerprint capturing device 212 is configured in the touch screen 204, and may be a part of the touch screen 204 or configured in the touch screen 204 in other ways. A main component of the fingerprint capturing device 212 may be a fingerprint sensor, which may adopt any type of sensing technology, including but not limited to optical, capacitive, piezoelectric or ultrasonic sensing technologies.

The mobile terminal 200 may also include a Bluetooth apparatus 205 for implementing data exchange between the mobile terminal 200 and other short-distance devices (such as a mobile phone, a smartwatch, etc.). Specifically, the Bluetooth apparatus 205 may be an integrated circuit or a Bluetooth chip, etc.

The mobile terminal 200 may further include at least one sensor 206, such as an optical sensor, a motion sensor, and other sensors. Specifically, the optical sensor may include an ambient light sensor and a proximity sensor, wherein the ambient light sensor may adjust the brightness of the display of the touch screen 204 according to the brightness of ambient light, and the proximity sensor may turn off a power supply of the display when the mobile terminal 200 moves to the ear. As one type of motion sensor, an accelerometer sensor can detect the magnitude of acceleration in all directions (typically in three axes), and can detect the magnitude and direction of gravity at rest, so as to be used for applications of recognizing a gesture of the mobile phone (such as portrait and landscape screen switching, related games, magnetometer gesture calibration), vibration recognition related functions (such as pedometers and taps) and the like. The mobile terminal 200 may also be equipped with other sensors, such as a gyroscope, a barometer, a hygrometer, a thermometer, an infrared sensor, etc., which are not described in detail here.

The WI-FI apparatus 207 is configured to provide the mobile terminal 200 with network access following WI-FI related standards and protocols, and the mobile terminal 200 may have access to a WI-FI access point through the WI-FI apparatus 207, to further assist the user in receiving or sending data, such as sending and receiving emails, browsing web interfaces and accessing streaming media, thereby providing wireless broadband internet access to the user. In other examples, the WI-FI apparatus 207 may also be used as a WI-FI wireless access point, which may provide WI-FI network access for other devices.

The positioning apparatus 208 is configured to provide geographic location information for the mobile terminal 200. It can be understood that the positioning apparatus 208 may specifically be a receiver of a global positioning system (GPS), a Beidou satellite navigation system, a Russian GLONASS and other positioning systems. After receiving the geographic location information sent by the above-mentioned positioning system, the positioning apparatus 208 can, for example, send the information to the processor 201 for processing or send the information to the memory 203 for storage. In other examples, the positioning apparatus 208 may also be a receiver of an assisted global positioning system (AGPS), and the AGPS system assists the positioning apparatus 208 in completing ranging and positioning services by serving as an auxiliary server. In this case, the auxiliary positioning server communicates with a device such as a positioning apparatus 208 (e.g., a GPS receiver) of the mobile terminal 200 through a wireless communication network to provide positioning assistance. In other examples, the positioning apparatus 208 may also be a positioning technology based on the WI-FI access point. Since each WI-FI access point has one globally unique media access control (MAC) address and the terminal device may scan and collect broadcast signals of the surrounding WI-FI access points when WI-FI is turned on, the MAC address broadcast by the WI-FI access points can be obtained. The terminal device sends these data (for example, MAC addresses) that may mark the WI-FI access points to a location server through the wireless communication network, and the location server retrieves a geographic location of each WI-FI access point, and calculates the geographic location of the terminal device in combination with the strength of the WI-FI broadcast signal and sends the geographic location to the positioning apparatus 208 of the terminal device.

The audio circuit 209 may include, for example, a speaker and a microphone for providing an audio interface between a user and the mobile terminal 200. The audio circuit 209 may convert the received audio data into an electrical signal, and transmit the electrical signal to the speaker, which converts the electrical signal into a sound signal and outputs the sound signal. On the other hand, the microphone converts the collected sound signal into an electrical signal, the electrical signal is received by the audio circuit 209 and converted into audio data, and then the audio data is output to the RF circuit 202 to be sent to another device, for example, or the audio data is output to the memory 203 for further processing.

The peripheral interface 210 is configured to provide various interfaces for external input/output devices (for example, a keyboard, a mouse, an external display, an external memory, a subscriber identity module card). For example, it is connected with a mouse through a universal serial bus (USB) interface, and connected with a subscriber identification module (SIM) provided by a telecom operator through a metal contact on a card slot of the SIM. The peripheral interface 210 may be used to couple the above-mentioned external input/output peripheral devices to the processor 201 and the memory 203.

The mobile terminal 200 may also include a power supply apparatus 211 (for example, a battery and a power management chip) for supplying power to various components, and the battery may be logically connected with the processor 201 through the power management chip, such that the functions of charging, discharging and power consumption management are implemented through the power supply apparatus 211.

Although not shown in FIG. 2, the mobile terminal 200 may also include a camera (a front camera and/or a rear camera), a flashlight, a micro projector, a near field communication (NFC) apparatus, etc., which will not be described in detail here.

The interface switching method described in the following embodiments may all be implemented in the mobile terminal 200 with the above-mentioned hardware structure. Nevertheless, it can be understood that the interface switching method described herein may also be applied to other suitable electronic devices, and is not limited to the mobile terminal described in conjunction with FIG. 2.

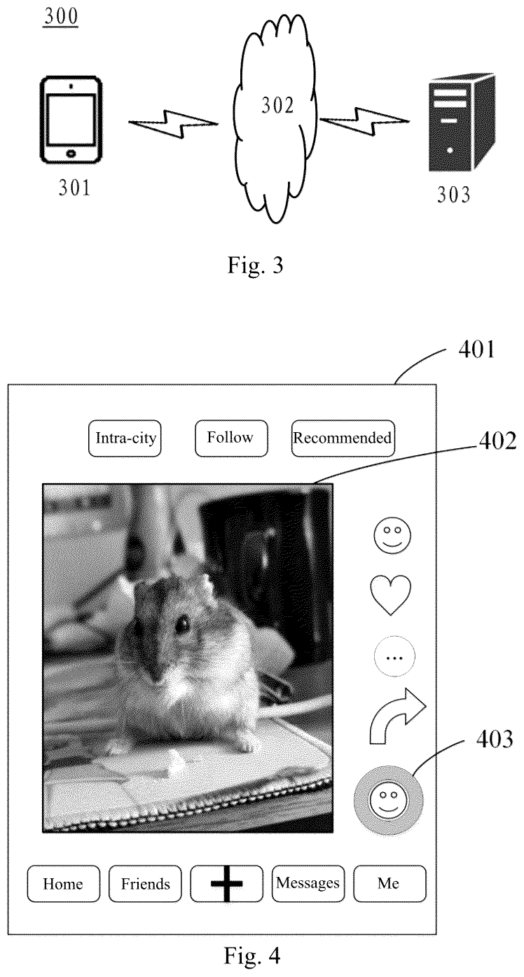

FIG. 3 shows a schematic diagram of an application scenario of a terminal device in an interaction system. As shown in FIG. 3, the interaction system may include, for example, a terminal device 301, a network 302, and a server 303.

The terminal device 301 may be a mobile terminal as shown or a fixed terminal, which performs data transmission with the server 303 through the network 302. Various application programs may be installed on the terminal device 301, such as a web browser application, a search application, a play application, a news information application, etc. In addition, the terminal device 301 includes an input/output apparatus, such that it may also receive user operations, such as touch and gesture operations through the touch screen, or voice operations through the microphone. Then, the terminal device 301 may generate a request message based on the received operation. Via the network 302, the terminal device 301 may send the above-mentioned request message to the server 303 and receive data returned by the server 303 in response to the request message. The terminal device 301 may display according to the data returned by the server 303, for example, display the received display data, such as a video or an image, on the display screen of the terminal device 301. In addition, the received data may also include other information, for example, a display time point and a duration of the video. Alternatively, the server 303 may directly send data to the terminal device 303 without receiving the request message, so as to perform corresponding processing on the terminal device 301.

The terminal device 301 may be in the form of hardware or software. When the terminal device 301 is in the form of hardware, it may be various devices which have a display screen and support program running. As described above, the terminal device 301 may be a mobile terminal shown, for example, which has the components described above in conjunction with FIG. 2. As other examples, the terminal device 301 may also be a smart TV, a tablet computer, an e-book reader, an MP4 (Moving Picture Experts Group Audio Layer IV) player, a laptop computer, a desktop computer, etc. When the terminal device 301 is in the form of software, it may be installed in the electronic devices listed above, and it may be implemented as multiple software or software modules (for example, software or software modules for providing distributed services) or as a single software or software module, which is not specifically limited here.

The network 302 may be a wired network or a wireless network, which is not limited here. The server 303 may provide various services, for example, receiving and caching a data stream sent by the terminal device 301. In addition, the server 303 may also receive the request message sent by the terminal device 301, analyze the request message, and send an analysis result (for example, a data stream corresponding to the request information) to the terminal device 301. Different servers may be arranged according to different application types. For example, the server 303 may be an instant messaging server, a payment application server, an information display application server, a resource management server, etc. It can be understood that the number of terminal devices 301, networks 302 and servers 303 shown in FIG. 3 is only for illustration. According to an actual application scenario, there may be any number of terminal devices, networks and servers.

Hereinafter, the interface switching method provided by the present disclosure will be described in detail with an example in which the switching of display interfaces of two content types is performed in an application program. As an example, in the embodiment described below, the current display content in the first display interface is a data stream corresponding to visual content, and the switching display content is a data stream corresponding to auditory content, that is, switching from an interface for visual content consumption by a user to an interface for auditory content consumption by the user is performed. It can be understood that the application scenario of the interface switching method according to the embodiment of the present disclosure is not limited to this.

According to some embodiments of the present disclosure, the determining switching display content to be displayed in response to the first dragging operation triggering an interface switching action includes: in response to the first dragging operation corresponding to dragging the first movable control to a target area in the first display interface, determining to perform the interface switching action and determining the switching display content.

As an implementation method, the movable control may be displayed at an edge position in the first display interface, such as a lower left edge position or a lower right edge position, and accordingly, the target area may be located at a middle potion of the first display interface and occupy a certain area.

As an example, FIG. 4 shows a schematic diagram of a first display interface displaying a first movable control. As shown in FIG. 4, the current display content 402 and the above-mentioned first movable control 403 are displayed in the first display interface 401. For example, the display interface may be displayed in full screen, that is, it completely covers the complete display screen of the mobile terminal. For another example, the display interface may also be displayed on the display screen of the terminal in the form of a pop-up, picture in picture, etc. In addition, the display interface may also cover only a part of the display screen, which is not limited here. Similarly, as shown in FIG. 4, the current display content 402 in the display interface 401 may occupy a part of the display interface, and in addition, the current display content 402 may also occupy the whole display interface, which is not limited here. In the example shown in FIG. 4, the first movable control 403 is located at a lower right corner of the first display interface, in which case, the current area may be provided at a middle position of the first display interface, for example. In other examples, the first movable control may also be located at other suitable positions. In addition, as shown in FIG. 4, other content may be displayed in the first display interface 401, such as icons and buttons shown at the top, bottom and right of the interface. The above-mentioned icons or buttons may be operable or inoperable, so as to implement functions related to the display interfaces, which are not limited here.

In the interface switching method according to some embodiments of the present disclosure, for the first display interface displaying the first movable control, the dragging operation for the movable control may be detected in real time. The detection may be implemented, for example, by the touch screen or the touchpad. Triggering operation results of the movable control may include two situations, wherein the first operation result indicates that the movable control is dragged to the target area, and the second operation result indicates that the movable control is not dragged to the target area. As an example, in response to detecting the first operation result, interface switching may be performed corresponding to the first operation result, that is, switching to the second display interface is performed. In response to detecting the second operation result, the interface switching action may not be triggered corresponding to the second operation result.

According to some embodiments of the present disclosure, the interface switching method may further include: displaying transitional content in the first display interface after the first dragging operation for the first movable control is detected. Specifically, the transitional content includes a first movable control, the first movable control being displayed in a mobile manner along with touch coordinates of the first dragging operation. In these embodiments, the transitional content may be displayed after the first dragging operation for the first movable control is detected and before switching to the second display interface is performed. For example, the transitional content may be used to display an intermediate process associated with the first dragging operation for the first movable control, which is beneficial for the user to obtain a visualization effect for the dragging operation more intuitively according to the transitional content.

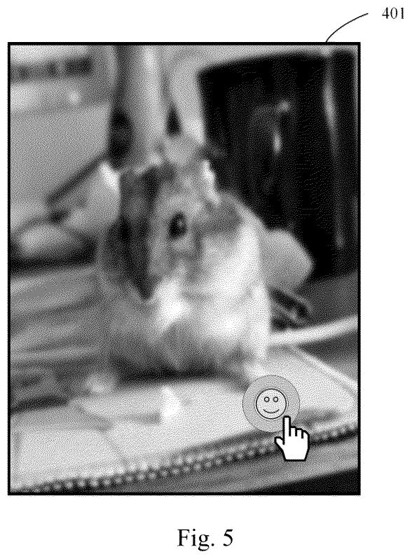

Specifically, FIG. 5 shows a schematic diagram of transitional content according to some embodiments of the present disclosure. As shown in FIG. 5, firstly, the transitional content includes a first movable control, the first movable control being displayed in a mobile manner along with touch coordinates of the first dragging operation. With reference to the control and a hand icon shown in FIG. 5, the user can understand a progress of the dragging operation based on both the control and the hand icon, for example, the control is displaced along with a dragging gesture of the user. As an example, the process of the control being displaced along with the dragging gesture of the user may be implemented by acquiring the touch coordinates for the touchpad in real time, that is, keeping the coordinates of the movable control displayed in the interface in synchronization with the touch coordinates.

In some embodiments according to the present disclosure, the transitional content may include a background image, wherein the background image is obtained based on a current display content picture in the first display interface. As an implementation, the background image may be a picture of the current display content displayed at a time point when the dragging operation starts; for example, if the current display content is a video, the background image may be a frame image displayed at the time point when the dragging operation starts. As another implementation, as shown in FIG. 5, the background image may be a blurred effect drawing of the picture of the current display content, for example, an image obtained after the above-mentioned frame image is blurred.

In other embodiments according to the present disclosure, the transitional content further includes a foreground image which may be obtained based on an interface color attribute of the second display interface, for example. As an example, the foreground image may refer to a mask layer. For example, a color of the mask layer is determined according to a color of a second display interface. For example, the color of the mask layer is consistent with the color of the second display interface, or the color changes from light to dark, and so on. For another example, in a case that the second display interface is a picture including multiple colors, the color with a maximum value range may also be calculated as the color of the foreground image. With respect to the foreground image, there may be other implementations.

According to some embodiments of the present disclosure, the first movable control being displayed in a mobile manner along with touch coordinates of the first dragging operation may include: when the first movable control is displayed in the mobile manner along with touch coordinates of the first dragging operation, the first movable control changes. For example, as shown in FIG. 5, the first movable control may have the shape of a record icon, and the record icon displayed in the transitional content may move along with the touch coordinates of the first dragging operation in a process of the dragging operation for the movable control by the user, and the display effect of the record icon may change in the moving process. As an implementation, the change may include changing a size of the record icon, for example, the size becomes larger with displacement until it is the same as a size of the target area. As another implementation, the change may include a change in the shape of the record icon, a change in a dynamic display effect, etc. In addition, the above-mentioned change may be implemented in other forms, which will not be described one by one.

In the above-mentioned embodiment in which the transitional content is displayed, in the process of the dragging operation for the movable control by the user, the transitional content can display the intermediate process corresponding to the dragging operation for the control and a corresponding display transition effect, which is beneficial for the user to obtain the visualization effect for the dragging operation more intuitively according to the transitional content; in addition, the transitional content also increases the interactivity of the dragging operation by the user and the man-machine interaction experience can be improved.

According to some embodiments of the present disclosure, the displaying transitional content in the first display interface may include: displaying a shape of the target area in the first display interface; and determining to perform the interface switching action in response to the touch coordinates of the first dragging operation being within the shape of the target area. In the process of performing dragging operation for the movable control by the user, the coordinates of an operation point may be detected, and in response to determining that the coordinates of the operation point are located in the target area, it is determined to trigger interface switching.

According to some embodiments of the present disclosure, the first movable control may be displayed in a first predetermined shape, and the target area may be displayed in a second predetermined shape, wherein the first predetermined shape is associated with the second predetermined shape.

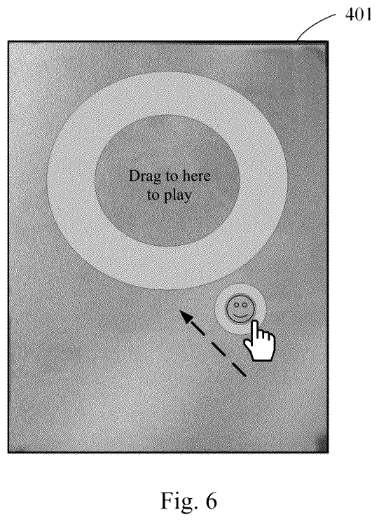

FIG. 6 shows another schematic diagram of transitional content according to some embodiments of the present disclosure. In the example of FIG. 6, the first movable control is displayed as the shape of a record icon, and the target area is displayed as the shape of a turntable icon of a record player. In the example shown in FIG. 6, the displayed shape of the first movable control is associated with the displayed shape of the target area, that is, the displayed shapes are the shape of a record. Specifically, the size of the turntable icon of the record player may be the same as the size of the target area.

Compared with the transitional content shown in FIG. 5, the background image of the transitional content shown in FIG. 6 may be a grayscale image to highlight the shapes of the movable control and the target area. As an implementation, in the process of the dragging operation for the movable control by the user, the transitional content shown in FIG. 5 may be displayed first, and then the transitional content shown in FIG. 6 may be displayed as the dragging operation progresses. For example, after detecting that the user selects the movable control 403 shown in FIG. 4 by clicking, the background image of this transitional content is obtained and displayed as shown in FIG. 5. Through this transitional content, the user can know that the dragging operation has been detected. Next, as the user drags the movable control to the target area, the transitional content shown in FIG. 6 may be displayed to further show a trend and progress of the dragging operation. According to the transitional content shown in FIG. 6, the user can intuitively understand the range of the target area of the dragging operation, and can be guided to drag the movable control to the target area to implement interface switching, such that a situation that an operation failure is caused by the fact that the user fails to drag to the target area is avoided.

The switching method according to some embodiments of the present disclosure may further include: displaying text information associated with the first dragging operation within the shape of the target area. For example, the content of the text information may be an illustrative description associated with the dragging operation, such as a text “Drag to play here” shown in FIG. 6. This part of text information may serve as a guidance for the user operation, which guides the user to switch an operation process in text, thus prompting the user to have an interaction feeling and deepening the interaction experience.

According to some embodiments of the present disclosure, the first movable control being displayed in a mobile manner along with touch coordinates of the first dragging operation includes: changing a display effect of the first predetermined shape in a process when the first movable control is displayed in a mobile manner along with touch coordinates of the first dragging operation, and associating the display effect of the first predetermined shape with the second predetermined shape in a case that the touch coordinates of the first dragging operation reach the target area.

It can be understood that FIG. 6 only shows a situation that the displayed shape is a turntable of the record player, and in this example, the target area is also correspondingly displayed in the shape of the turntable of the record player, thus achieving the correlation between them in terms of the display effect. In other application situations, the shape of the movable control may be displayed as a book, and accordingly, the shape of the target area may be displayed as a desk lamp. Alternatively, the shape of the movable control is displayed as a radio, and accordingly, the shape of the target area may be displayed as something associated with the radio, etc. That is, the displayed shape of the target area may be associated with the displayed shape of the movable control as described above.

In addition, as described above, a change occurs when the movable control is displayed in a mobile manner along with touch coordinates of the dragging operation. As shown in FIG. 6, in the process in which the movable control moves to the target area along with the touch coordinates, a size of the movable control may be changed, for example, the size of the movable control is continuously enlarged with the shortening of a distance from the target area, and when the movable control moves to the target area, it is enlarged to the same size as the turntable of the record player corresponding to the target area. In addition, corresponding to the change of the movable control, the displayed shape of the target area may also change during the above-mentioned movement. For example, it may be a change in display color, a change in shape, or a change in the dynamic display effect. For example, the change of the displayed shape of the target area may be associated with the change of the movable control during the movement to form a visual echo effect, etc.

According to some embodiments of the present disclosure, in response to the first dragging operation corresponding to dragging the first movable control to the target area in the first display interface, it is determined to perform the interface switching action and display the switching display content on the second display interface. For example, the switching display content may include one or more sub-categories of display content. In a case that the switching display content corresponds to the data stream of the auditory content, as an example, the switching display content may include a sub-category of music, for example, such display content is used to provide a music data stream. In addition, as other examples, the switching display content may also include sub-categories other than music. For example, the switching display content may include a sub-category corresponding to a radio station for providing broadcast data streams. For another example, the switching display content may also include a sub-category corresponding to novel data streams for providing novel reading resources. The sub-categories of the switching display content are not limited here.

According to some embodiments of the present disclosure, determining the switching display content may include determining the switching display content according to a background audio associated with the first display content, or determining the switching display content according to playing information corresponding to the first display interface.

For example, the current display content in the first display interface may include a video, and the video may have background music, on which basis the switching display content may be determined. For example, the above-mentioned background music may be a segment corresponding to a song, thus the switching display content may be a partial segment or the entire content of the song. In addition, the switching display content may be randomly determined without any information.

For another example, the switching display content may be determined according to associated data corresponding to current play information, historical play information, user attribute information and the like in the first display interface. As an example, the terminal device, for example, may collect current play information, historical play information, and user attribute information with user authorization. For example, historical play information may be information displayed on the switching display interface after the last interface switching is performed, such as songs played more times. For example, the user attribute information may be user location information, etc., wherein the user location information may indicate the current location information of the terminal device described above. For example, in a case that the user attribute information includes the user location information, the corresponding switching display content, such as location-related broadcast data, may be recommended based on the location information, thus achieving personalized display content recommendation on the second display interface after switching.

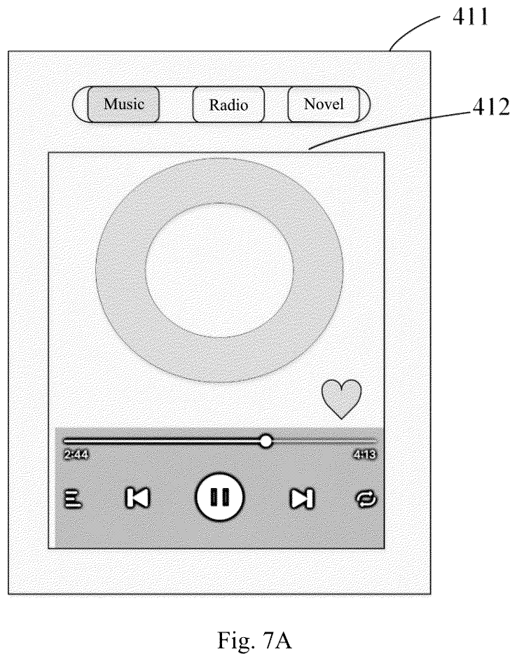

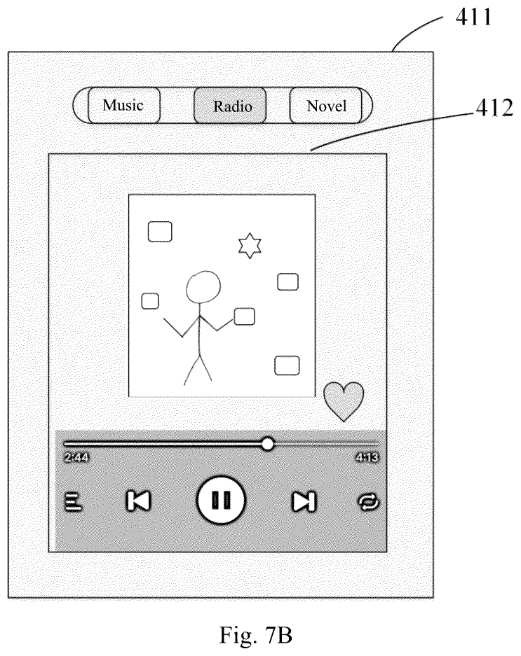

FIGS. 7A and 7B respectively show schematic diagrams of a second display interface after switching. As shown in FIGS. 7A and 7B, switching display content 412 is displayed in a second display interface 411. For example, the switching display content 412 includes three sub-categories (or called three tabs), namely, music, radio and novel. In addition, the second display interface may also include other information related to playback, such as category labels at the top and a playback progress at the bottom, etc., which is not limited here. In addition, in the second display interface, the user may also switch sub-categories based on the category labels at the top, wherein FIG. 7A shows a situation that the current display content is the music tab, and FIG. 7B shows a situation that the current display content is the radio tab.

The interface switching method according to some embodiments of the present disclosure may further include: acquiring a second dragging operation for a second movable control in the second display interface after displaying the switching display content in the second display interface; and in response to the second dragging operation corresponding to dragging the second movable control to a predetermined area, switching to the first display interface and displaying the current display content in the first display interface. Through the dragging operation on the second movable control in the second display interface, it is possible to switch back from the second display interface to the first display interface, and in addition, the current display content described above may continue to be displayed after switching back to the first display interface.

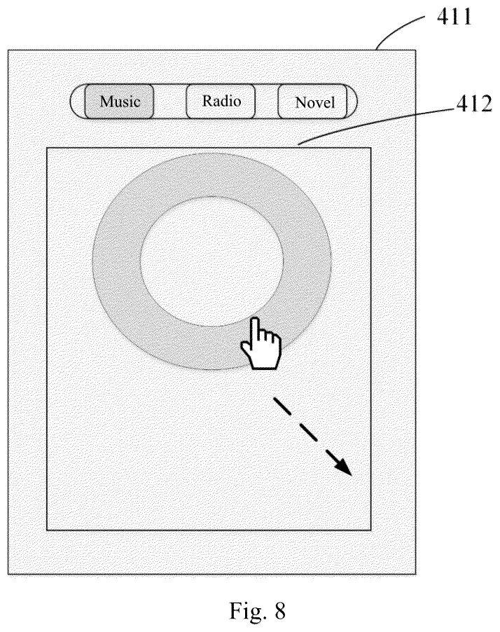

FIG. 8 shows a schematic diagram of a second display interface displaying a second movable control. As shown in FIG. 8, the second movable control is displayed in the shape of a music turntable at a middle position of 412. After the dragging operation for the movable control is detected, the transitional content may be displayed on the second display interface. As an example, the transitional content includes the second movable control, a hand icon and a direction identifier such as indicating an operation direction. Based on this, the user may switch back to the second display interface by dragging the movable control to the predetermined area. For example, the predetermined area may correspond to a position where the first movable control is displayed in the first display interface, for example, a position where the movable control 403 at a lower right corner of the first display interface is located as shown in FIG. 4.

According to some embodiments of the present disclosure, in a case that the switching display content includes N sub-categories of display content and N is an integer greater than 1, the corresponding switching display content may also be determined based on the operation angle of the dragging operation for the first movable control. Specifically, the position of the first movable control displayed in the first display interface may be taken as a dragging starting position in advance, and the first display interface may be divided into N dragging angle ranges based on the dragging starting position, wherein the N dragging angle ranges respectively correspond to N sub-categories of display content, and as an example, N is equal to 3, and the three sub-categories are music, radio and novel shown in FIGS. 7A and 7B respectively. Next, the determining switching display content to be displayed in response to the first dragging operation triggering an interface switching action may include: determining a dragging angle range to which a dragging angle of the first dragging operation belongs among the N dragging angle ranges, and determining the corresponding switching display content based on the dragging angle range to which the dragging angle belongs.

According to some embodiments of the present disclosure, the transitional content may also be displayed in the first display interface after the first dragging operation for the first movable control is detected, wherein the transitional content is associated with the dragging angle range to which the dragging angle of the first dragging operation belongs among the N dragging angle ranges.

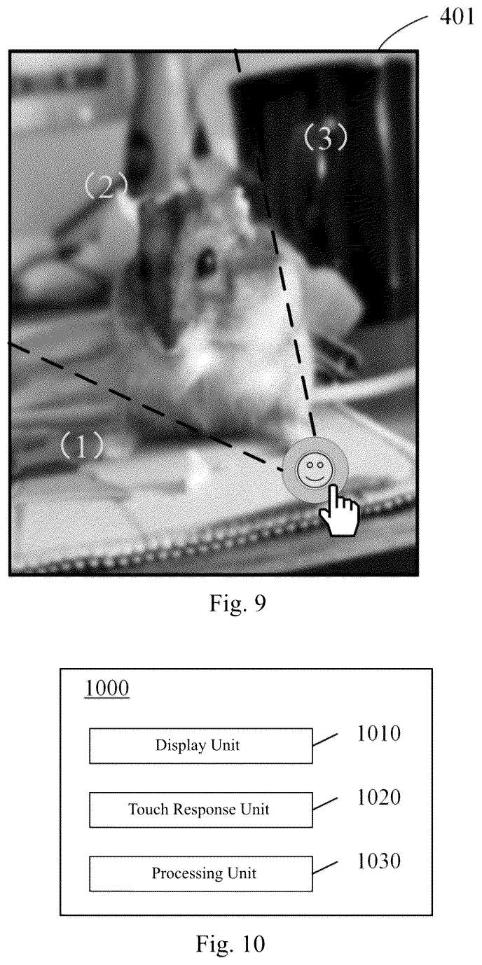

As an example, FIG. 9 shows a schematic diagram of a dragging angle range according to some embodiments of the present disclosure. After the first dragging operation for the first movable control 403 in the first display interface is detected, the transitional content as shown in FIG. 9 may be displayed. As an example, three angle ranges starting from the first movable control are shown in the first display interface with black dashed lines, such that the range to which the current dragging angle range belongs may be determined as one of the shown ranges (1), (2) and (3) along with the moving direction of the dragging operation. Next, the sub-category of the corresponding switching display content may be determined based on the dragging angle range to which the current dragging angle belongs. As an example, the dragging operation corresponding to the dragging angle range (1) may take the data stream of the music category as the switching display content, for example, the data stream of the music type is directly played after switching to the second display interface is performed.

According to some embodiments of the present disclosure, the first display interface may also be divided into N dragging areas, and the N dragging areas respectively correspond to the N sub-categories of display content. Specifically, the determining switching display content to be displayed in response to the first dragging operation triggering an interface switching action includes: determining a dragging area to which a dragging arrival position of the first dragging operation in the first display interface belongs among the N dragging areas, and determining the corresponding switching display content based on the dragging area to which the dragging arrival position belongs. In addition, the transitional content in the first display interface may also be displayed after the first dragging operation for the first movable control is detected, wherein the transitional content is associated with the dragging area to which the dragging arrival position of the first dragging operation in the first display interface belongs among the N dragging areas.

In these embodiments, the sub-category of the corresponding switching display content is determined based on the dragging area of the dragging operation for the first movable control. As an example, in a case of determining the data of the radio sub-category as the switching display content based on the dragging area, the data stream from the radio may be directly played after switching to the second display interface.

According to the interface switching method provided by the present disclosure, by further utilizing information such as the dragging angle and the dragging area of the detected dragging operation by the user, display content of corresponding categories may be provided based on different dragging angles and dragging areas so as to be displayed in the switching display interface. Thus, the dragging operation of the user as input information can trigger interface switching, and further affect the subsequent display content, which enriches the interaction experience of the user and improves the intelligence of the switching operation in the process of operating through the movable controls.

By the interface switching method according to some embodiments of the present disclosure, the switching of display interfaces is implemented based on the displayed first movable control, such that the switching between different display interfaces can be implemented through the intuitive dragging operation by the user, the interaction operation is simple, and a visual display effect, implementation of operations and other aspects are more simple and intuitive than the existing operation modes such as clicking, double-clicking and sliding, which facilitates the improvement of an operation effect of interaction between the user and, for example, a terminal device.

According to another aspect of the present disclosure, there is also provided an interface switching apparatus. FIG. 10 shows a schematic block diagram of an interface switching apparatus provided by at least some embodiments of the present disclosure. According to some embodiments of the present disclosure, the interface switching apparatus can implement the interface switching method as described above based on functional units configured therein.

Specifically, as shown in FIG. 10, the interface switching apparatus 1000 may include a display unit 1010, a touch response unit 1020 and a processing unit 1030. According to some embodiments of the present disclosure, the display unit 1010 can be configured to: display a first movable control in a first display interface of a target application. The touch response unit 1020 can be configured to: acquire a first dragging operation for the first movable control. and the processing unit 1030 can be configured to: determine switching display content to be displayed in response to the first dragging operation triggering an interface switching action, and switch from the first display interface to a second display interface of the target application and control the display unit 1010 to display the switching display content in the second display interface.

As an implementation, the display unit 1010 may include a display panel. Optionally, the display panel may be in the form of a liquid crystal display (LCD), an organic light-emitting diode display (OLED), etc. The display panel may be used to display information input by or provided to the user and various graphical user interfaces, which graphical user interfaces may be composed of graphics, texts, icons, videos and any combination thereof. In addition, the display unit 1010 may also include an audio circuit for displaying the data stream corresponding to auditory content, such as a background audio, a broadcast, etc.

As an implementation, the touch response unit 1020 may be implemented as a touch-sensitive surface or other input interfaces. For example, the touch-sensitive surface may also be configured as a touch screen (for example, the touch screen 204 shown in FIG. 2, which includes a touchpad 204-1 and a display 204-2) for collecting touch operations on or near the touch-sensitive surface by the user, such as operations of the user using any suitable objects or accessories such as a finger, a stylus, etc., and for driving corresponding functional units according to a preset program. Optionally, the touch-sensitive surface may include two parts: a touch detection apparatus and a touch control apparatus. The touch detection apparatus detects a touch orientation of the user, detects a signal brought by the touch operation and transmits the signal to the touch control apparatus. The touch control apparatus receives touch-related parameters from the touch detection apparatus, transforms the parameters into contact coordinates, then transmits the contact coordinates to, for example, the processing unit 1030, and then may receive instructions sent by the processing unit 1030 and execute the instructions. In addition, the touch-sensitive surface may be implemented as various types, such as resistive, capacitive, infrared and surface acoustic wave touchpads. In addition to the touch-sensitive surface, the touch response unit 1020 may also include other input interfaces. Specifically, other input interfaces may include, but are not limited to, one or more of a physical keyboard, function keys (such as volume control buttons, switch buttons, etc.), a trackball, a mouse, a joystick, etc.

The touch-sensitive surface of the touch response unit 1020 may cover the above-mentioned display panel, and when the touch-sensitive surface detects a touch operation on or near it, the touch operation is transmitted to, for example, the processing unit 1030 to determine parameters of the touch operation, and then the processing unit 1030 may provide corresponding visual or auditory output on the display panel according to the parameters of the touch operation.

As an implementation, the above-mentioned processing unit 1030 may be implemented as a logical operation center of a terminal device, which uses various interfaces and lines to link various functional units of the device, and executes various functions and processes data by running or executing software programs and/or modules stored in a memory and calling data stored in the memory. Optionally, the processing unit 1030 may be implemented as one or more processor cores. For example, the processing unit may be integrated with an application processor and a modem processor, wherein the application processor mainly processes an operating system, a user interface and an application program, etc., and the modem processor mainly processes wireless communication. It can be understood that the above-mentioned modem processor may not be integrated into the processing unit 1030.

Some functions implemented by the various units in the interface switching apparatus according to some embodiments of the present disclosure are described below.

According to some embodiments of the present disclosure, the determining switching display content to be displayed in response to the first dragging operation triggering an interface switching action by the processing unit 1030 includes: in response to the first dragging operation corresponding to dragging the first movable control to a target area in the first display interface, determining to perform the interface switching action and determining the switching display content.

According to some embodiments of the present disclosure, the processing unit 1030 is further configured to: control the display unit 1010 to display transitional content in the first display interface after the first dragging operation for the first movable control is detected, wherein the transitional content includes the first movable control, the first movable control being displayed in a mobile manner along with touch coordinates of the first dragging operation.

According to some embodiments of the present disclosure, the first movable control being displayed in a mobile manner along with touch coordinates of the first dragging operation includes: when the first movable control is displayed in the mobile manner along with touch coordinates of the first dragging operation, the first movable control changes.

According to some embodiments of the present disclosure, the transitional content further includes a background image obtained based on a current display content picture in the first display interface; and/or the transitional content further includes a foreground image obtained based on an interface color attribute of the second display interface.

According to some embodiments of the present disclosure, the displaying, by the display unit 1010, transitional content in the first display interface includes: displaying a shape of the target area in the first display interface; and determining to perform the interface switching action in response to the touch coordinates of the first dragging operation being within the shape of the target area.

According to some embodiments of the present disclosure, the processing unit 1030 is further configured to control the display unit 1010 to display text information associated with the first dragging operation within the shape of the target area.

According to some embodiments of the present disclosure, the first movable control is displayed in a first predetermined shape, the target area is displayed in a second predetermined shape, and the first predetermined shape is associated with the second predetermined shape.

According to some embodiments of the present disclosure, the first movable control being displayed in a mobile manner along with touch coordinates of the first dragging operation includes: changing a display effect of the first predetermined shape in a process when the first movable control is displayed in a mobile manner along with touch coordinates of the first dragging operation, and associating the display effect of the first predetermined shape with the second predetermined shape in a case that the touch coordinates of the first dragging operation reach the target area.

According to some embodiments of the present disclosure, the switching display content includes N sub-categories of display content, N is an integer greater than 1, the first display interface is divided into N dragging angle ranges with a position of the first movable control displayed in the first display interface as a dragging starting position, and the N dragging angle ranges respectively correspond to the N sub-categories of display content, wherein the determining switching display content to be displayed in response to the first dragging operation triggering an interface switching action by the processing unit 1030 includes: determining a dragging angle range to which a dragging angle of the first dragging operation belongs among the N dragging angle ranges, and determining the corresponding switching display content based on the dragging angle range to which the dragging angle belongs.

According to some embodiments of the present disclosure, the processing unit 1030 may be further configured to: control the display unit 1010 to display the transitional content in the first display interface after the first dragging operation for the first movable control is detected, wherein the transitional content is associated with the dragging angle range to which the dragging angle of the first dragging operation belongs among the N dragging angle ranges.

According to some embodiments of the present disclosure, the switching display content includes N sub-categories of display content, N is an integer greater than 1, the first display interface is divided into N dragging areas, the N dragging areas respectively correspond to the N sub-categories of display content, wherein the determining switching display content to be displayed in response to the first dragging operation triggering an interface switching action by the processing unit 1030 includes: determining a dragging area to which a dragging arrival position of the first dragging operation in the first display interface belongs among the N dragging areas, and determining the corresponding switching display content based on the dragging area to which the dragging arrival position belongs.

According to some embodiments of the present disclosure, the processing unit 1030 is further configured to: control the display unit 1010 to display the transitional content in the first display interface after the first dragging operation for the first movable control is detected, wherein the transitional content is associated with the dragging area to which the dragging arrival position of the first dragging operation in the first display interface belongs among the N dragging areas.

According to some embodiments of the present disclosure, before switching to the second display interface is performed, the current display content is displayed in the first display interface, and the processing unit 1030 is further configured to: acquire a second dragging operation for a second movable control in the second display interface after displaying the switching display content in the second display interface; and in response to the second dragging operation corresponding to dragging the second movable control to a predetermined area, switch to the first display interface and control the display unit 1010 to display the current display content in the first display interface.

According to some embodiments of the present disclosure, the current display content is one of a data stream corresponding to visual content and a data stream corresponding to auditory content, and the switching display content is the other one of the data stream corresponding to the visual content and the data stream corresponding to the auditory content.

It is noted that in the process of switching interfaces based on the displayed movable controls, the interface switching apparatus provided according to the embodiments of the present disclosure is exemplified by the division of the above functional units, and in practical applications, the above functional units may be completed by different circuits as needed, for example, an internal structure of the terminal device is divided into different circuits to complete all or part of the steps described above. In addition, the interface switching apparatus provided by the above-mentioned embodiment may implement the steps of the interface switching method provided by the present disclosure, and the specific implementation processes refer to the method embodiment described above, which are omitted here.

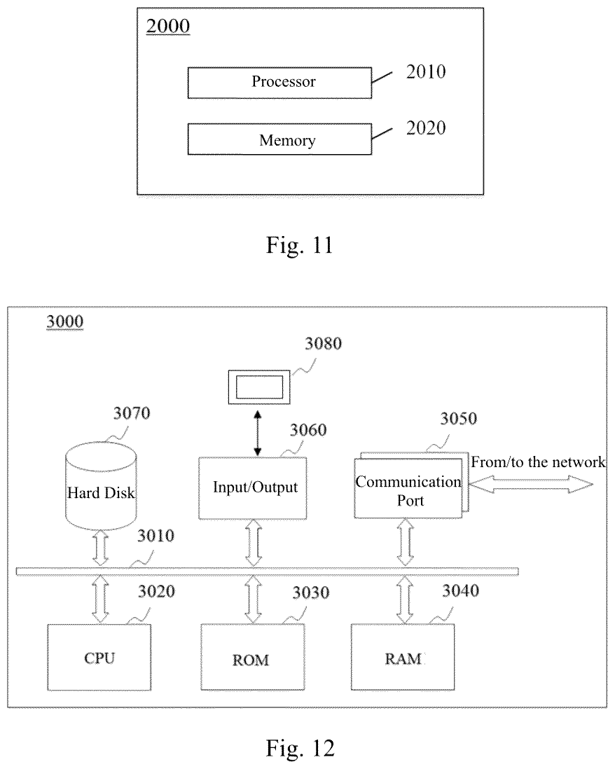

According to yet another aspect of the present disclosure, there is also provided an electronic device, and FIG. 11 shows a schematic block diagram of the electronic device according to an embodiment of the present disclosure.

As shown in FIG. 11, the electronic device 2000 may include a processor 2010 and a memory 2020, wherein the memory 2020 has stored thereon a computer program (such as a program instruction, a code, etc.). The processor 2020 can execute the computer program to implement the steps of the interface switching method as described above. As an example, the electronic device 2000 may be a terminal device on which a user logs in an account.

In at least one example, the processor 2010 may perform various actions and processes according to the computer program stored in the memory 2020. For example, the processor 2010 may be an integrated circuit chip with signal processing capability. The processor above may be a general-purpose processor, a digital signal processor (DSP), an application-specific integrated circuit (ASIC), a field programmable gate array (FPGA) or other programmable logic device, a transistor logic device, and a discrete hardware component. The various methods, steps and logic blocks disclosed in the embodiments of the present invention may be implemented or executed. The general-purpose processor may be a microprocessor or any conventional processor, and it may be an X86 architecture or an ARM architecture.

A computer program executable by a computer is stored in the memory 2020, and the computer program, when executed by the processor 2010, may implement the interface switching method provided according to some embodiments of the present disclosure. The memory 2020 may be a volatile memory or a nonvolatile memory, or may include both the volatile and nonvolatile memories. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which is used as an external cache. By way of illustration but not limitation, numerous forms of RAMs are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM) and a direct rambus random access memory (DR RAM). It should be noted that the memories described herein are intended to include, but are not limited to, these and any other suitable types of memories.

According to other embodiments of the present disclosure, the electronic device 2000 may further include a display (not shown) to implement visualization for a computer operator. For example, information such as the display content, the movable controls and data processing results in the process of implementing the interface switching method described above may be displayed on the display, or information related to application programs may also be displayed, which is not limited here. In addition, the electronic device 2000 may also include necessary components such as an interaction interface, an input device, a communication unit, etc., for implementing information interaction between the computer and the operator and other devices, for example, the operator may modify the computer program through the input device.

As one of the exemplary implementations, the interface switching apparatus 1000 or the electronic device 2000 according to the present disclosure may also be implemented as a computing device as shown in FIG. 12.

FIG. 12 shows an architectural schematic diagram of an exemplary computing device according to an embodiment of the present disclosure. The computing device 3000 may include a bus 3010, one or more CPU 3020, a read-only memory (ROM) 3030, a random access memory (RAM) 3040, a communication port 3050 connected to a network, an input/output component 3060, a hard disk 3070, etc. A storage device in the computing device 3000, such as the ROM 3030 or the hard disk 3070, may store various data or files involved in the processing and/or communication of the interface switching method provided by the present disclosure, as well as computer programs executed by the CPU. The computing device 3000 may also include a user interface 3080. For example, the user interface may be used to display the display content and movable controls, and may also receive the touch operation of the user through a touch-sensitive device thereon. Certainly, the architecture shown in FIG. 12 is only schematic. When implementing different devices, one or more components in the computing device shown in FIG. 12 may be omitted or required components may be added on the basis of the computing device shown in FIG. 12 according to actual needs, which is not limited here.

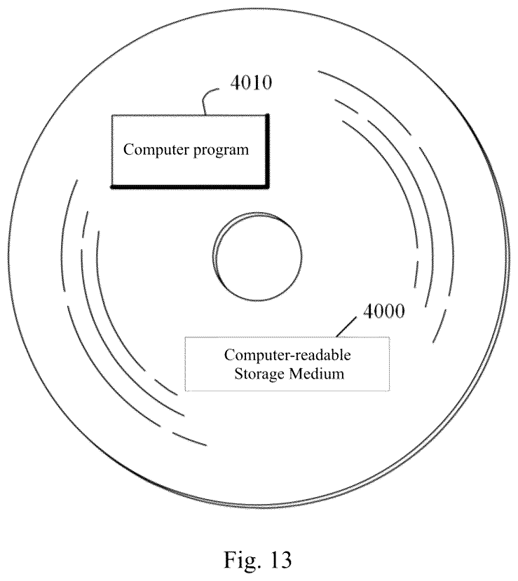

According to yet another aspect of the present disclosure, there is also provided a computer-readable storage medium, and FIG. 13 shows a schematic block diagram of the computer-readable storage medium provided by the present disclosure.

As shown in FIG. 13, a computer program 4010 is stored on a computer-readable storage medium 4000, wherein the computer program 4010, when executed by a processor, implements the steps of the interface switching method as described above. In at least one example, the computer-readable storage medium 4000 includes, but is not limited to, a volatile memory and/or a nonvolatile memory. The volatile memory may include, for example, a random access memory (RAM) and/or a cache, etc. The nonvolatile memory may include, for example, a read-only memory (ROM), a hard disk, a flash memory, etc. For example, the computer-readable storage medium 4000 may be connected to a computing device such as a computer (for example, as shown in FIG. 12). Next, the interface switching method provided by the present disclosure may be performed in a case that the computing device runs the computer program 4010 stored on the computer-readable storage medium 4000.

According to yet another aspect of the present disclosure, there is also provided a computer program product, including a computer program. In at least one example, the computer program, when executed by a processor, can implement the steps of the interface switching method as described above.

Those skilled in the art will appreciate that the disclosure may be susceptible to variations and modifications. For example, various devices or components described above may be implemented by hardware, or may be implemented in software and firmware, or a combination of some of all of hardware, software and firmware.

In addition, while the present disclosure makes various references to certain units of a system according to embodiments of the present disclosure, any number of different units may be used and run on a client and/or the server. The units are merely illustrative, and different units may be used for different aspects of the system and the method.

Flowcharts are used in the present disclosure to illustrate the steps of the method according to the embodiment of the present disclosure. It should be understood that the preceding or following steps are not necessarily performed in the exact order shown. Instead, the various steps may be processed in a reverse order or simultaneously. Meanwhile, other operations may be added to these processes.

It can be understood by those of ordinary skill in the art that all or a part of the steps of the method described above may be implemented by a computer program instructing relevant hardware, which program may be stored in a computer-readable storage medium, such as a read-only memory, a magnetic disk or an optical disk, etc. Optionally, all or a part of the steps of the above-mentioned embodiment may also be implemented by one or more integrated circuits. Accordingly, the modules/units in the above-mentioned embodiments may be implemented in the form of hardware or may also be implemented in the form of software functional modules. The present disclosure is not limited to any specific form of combination of hardware and software.

Unless otherwise defined, all techniques used herein have the same meaning as those commonly understood by ordinary technical personnel in the field to which this disclosure belongs. It should also be understood that terms such as those defined in regular dictionaries should be interpreted as having meanings that are consistent with their meanings in the context of the relevant technology, and should not be interpreted in idealized or overly formal terms, unless explicitly defined here.

The above is an explanation of this disclosure and should not be considered as a limitation. Although several exemplary embodiments of the present disclosure have been described, those skilled in the art will easily understand that many modifications can be made to the exemplary embodiments without departing from the novel teaching and advantages of the present disclosure. Therefore, all these modifications are intended to be included within the scope of this disclosure as limited by the claims. It should be understood that the above is an explanation of the present disclosure and should not be considered limited to the specific embodiments disclosed, and the intention to modify the disclosed embodiments and other embodiments is included within the scope of the attached claims. This disclosure is limited by the claims and their equivalents.

1. An interface displaying method, wherein a first movable control is displayed in a first display interface, and the method comprises:
acquiring a first dragging for the first movable control;
determining target display content to be displayed in response to the first dragging; and
displaying the target display content in the second display interface for replacing the displaying of the first display interface.

2. The method according to claim 1, wherein the determining target display content to be displayed in response to the first dragging comprises:
in response to the first dragging corresponding to dragging the first movable control to a target area in the first display interface, determining to perform an interface switching action and determining the switching display content.

3. The method according to claim 2, further comprising:
displaying transitional content in the first display interface after the first dragging for the first movable control is detected, wherein the transitional content comprises the first movable control, the first movable control being displayed in a mobile manner along with touch coordinates of the first dragging.

4. The method according to claim 3, wherein the first movable control being displayed in a mobile manner along with touch coordinates of the first dragging comprises:
when the first movable control is displayed in the mobile manner along with touch coordinates of the first dragging, the first movable control changes.

5. The method according to claim 3, wherein,
the transitional content further comprises a background image obtained based on a current display content picture in the first display interface; and/or
the transitional content further comprises a foreground image obtained based on an interface color attribute of the second display interface.

6. The method according to claim 3, wherein the displaying transitional content in the first display interface comprises:
displaying a shape of the target area in the first display interface; and
determining to perform the interface switching action in response to the touch coordinates of the first dragging being within the shape of the target area.

7. The method according to claim 5, further comprising:
displaying text information associated with the first dragging within the shape of the target area.

8. The method according to claim 3, wherein the first movable control is displayed in a first predetermined shape, the target area is displayed in a second predetermined shape, and the first predetermined shape is associated with the second predetermined shape.

9. The method according to claim 8, wherein the first movable control being displayed in a mobile manner along with touch coordinates of the first dragging comprises:
changing a display effect of the first predetermined shape in a process when the first movable control is displayed in a mobile manner along with touch coordinates of the first dragging, and associating the display effect of the first predetermined shape with the second predetermined shape in a case that the touch coordinates of the first dragging reach the target area.

10. The method according to claim 1, wherein the target display content comprises N sub-categories of display content, N is an integer greater than 1, the first display interface is divided into N dragging angle ranges with a position of the first movable control displayed in the first display interface as a dragging starting position, and the N dragging angle ranges respectively correspond to the N sub-categories of display content,
the determining target display content to be displayed in response to the first dragging comprises:
determining a dragging angle range to which a dragging angle of the first dragging belongs among the N dragging angle ranges, and determining the corresponding target display content based on the dragging angle range to which the dragging angle belongs.

11. The method according to claim 10, further comprising:
displaying transitional content in the first display interface after the first dragging for the first movable control is detected, wherein the transitional content is associated with the dragging angle range to which the dragging angle of the first dragging belongs among the N dragging angle ranges.

12. The method according to claim 1, wherein the target display content comprises N sub-categories of display content, N is an integer greater than 1, and the first display interface is divided into N dragging areas, and the N dragging areas respectively correspond to the N sub-categories of display content,
the determining target display content to be displayed in response to the first dragging comprises:
determining a dragging area to which a dragging arrival position of the first dragging in the first display interface belongs among the N dragging areas, and determining the corresponding target display content based on the dragging area to which the dragging arrival position belongs.

13. The method according to claim 12, further comprising:
displaying transitional content in the first display interface after the first dragging for the first movable control is detected, wherein the transitional content is associated with the dragging area to which the dragging arrival position of the first dragging in the first display interface belongs among the N dragging areas.

14. The method according to claim 1, wherein before switching to the second display interface is performed, current display content is displayed in the first display interface, and the method further comprises:
acquiring a second dragging for a second movable control in the second display interface after displaying the target display content in the second display interface; and
in response to the second dragging corresponding to dragging the second movable control to a predetermined area, switching to the first display interface and displaying the current display content in the first display interface.

15. The method according to claim 1, wherein the current display content is one of a data stream corresponding to visual content and a data stream corresponding to auditory content, and the target display content is the other one of the data stream corresponding to the visual content and the data stream corresponding to the auditory content.

16. An interface displaying apparatus, comprising:
a display unit configured to: display a first movable control in a first display interface;
a touch response unit configured to: acquire a first dragging for the first movable control; and
a processing unit configured to: determine target display content to be displayed in response to the first dragging and control the display unit to display the target display content in the second display interface for replacing the displaying of the first display interface.

17. The apparatus according to claim 16, wherein the determining target switching display content to be displayed in response to the first dragging triggering an by the processing unit comprises:
in response to the first dragging corresponding to dragging the first movable control to a target area in the first display interface, determining to perform an interface switching action and determining the target display content.

18. The apparatus according to claim 16, wherein the processing unit is further configured to:
control the display unit to display transitional content in the first display interface after the first dragging for the first movable control is detected, wherein the transitional content comprises the first movable control, and the first movable control is displayed in a mobile manner along with touch coordinates of the first dragging.

19. An electronic device, comprising a memory, a processor and a computer program stored in the memory, wherein the computer program, upon executed by the processor, cause the processor to:
acquire a first dragging for a first movable control which is displayed in a first display interface;
determine target display content to be displayed in response to the first dragging; and
display the target display content in the second display interface for replacing the displaying of the first display interface.

20. A nonvolatile computer-readable storage medium having a computer program stored thereon, wherein the computer program, when executed by a processor, cause the processor to implement the steps of the method according to claim 1.
